(19) United States
(12) Patent Application Publication
(10) Pub. No.: US 2015/0082789 A1
(43) Pub. Date: Mar. 26, 2015

(54) TWO-STAGE TURBOCHARGER SYSTEM

(71) Applicant: GM GLOBAL TECHNOLOGY OPERATIONS LLC, Detroit, MI (US)

(72) Inventors: Hans DRANGEL, Stockholm (SE); Riccardo Franz TURCATO, Montalto Dora (TO) (IT)

(21) Appl. No.: 14/494,351

(22) Filed: Sep. 23, 2014

(30) Foreign Application Priority Data
Sep. 23, 2013 (GB) 1316866.1

(51) Int. Cl. F02B 37/18; F02B 29/04; F02D 41/00; F02B 37/00

(52) U.S. Cl. CPC F02B 37/183; F02B 37/004; F02B 29/0406; F02D 41/0007; F02D 2250/34
USPC 60/602; 60/605.1; 123/542; 60/612; 123/462

(57) ABSTRACT

A two-stage turbocharger system for an internal combustion engine is disclosed. The turbocharger system includes a high pressure turbine coupled to an exhaust manifold of the internal combustion engine, and a low pressure turbine having an inlet coupled to the high pressure turbine and an outlet coupled to an exhaust system of the engine. The turbocharger further includes a low pressure compressor having an inlet coupled to environment and an outlet coupled to a high pressure compressor. The high pressure compressor is coupled to an intake manifold of the internal combustion engine. The high pressure turbine is provided with a high pressure by-pass line having a high pressure controlled by-pass valve. The low pressure turbine is provided with a low pressure by-pass line having a low pressure controlled by-pass valve. A controlled valve is provided between the high pressure turbine and the low pressure turbine.

### CROSS REFERENCE TO RELATED APPLICATION

This application claims priority to Great Britain Patent Application No. 1316866.1 filed Sep. 23, 2013, which is incorporated herein by reference in its entirety.

### TECHNICAL FIELD

The technical field relates to a two-stage turbocharger system and more particularly a two-stage turbocharger suitable for high powered internal combustion engines such as Diesel cycle engines having a high specific power.

### BACKGROUND

A turbocharger or “turbo” in short, is a forced induction device used to allow more power to be produced for an engine of a given size. The benefit of a turbo is that it compresses a greater mass of intake air into the combustion chamber, thereby resulting in increased power and/or efficiency. Turbochargers are commonly used on truck, car, train and construction equipment engines. They are popularly used with Otto cycle and Diesel cycle internal combustion engines and have also been found useful in automotive fuel cells. Also known is the two-stage turbocharger which can be used for high performance engines.

An example of a two-stage turbocharger system is described in DE 10 2004 061 023 A1. It discloses an engine, having an exhaust gas super-charger arrangement with two exhaust gas turbo-chargers, where one of the exhaust gas turbo-chargers is switchable. The two exhaust gas turbo-chargers are connected with each other such that supercharged air compressed by one of the turbo-chargers is repressed intermittently with the other turbo-charger. An intercooler is arranged for intercooling of supercharged air.

One current solution for two-stage charging systems is the so called “Serial sequential” type. This means that the peak power operation is performed with the use of only one turbocharger (the low pressure turbocharger). When only one turbocharger is used the single low pressure compressor has to provide a pressure ratio of about 4 to supply air for a high powered engine, whose specific power output is in the range of 90 kW/l. This high pressure ratio leads to high value of the compressor outlet temperatures and consequent oil coking in the compressor.

Another solution for two-stage charging system is the so called “full series” mode. According to this solution, the whole intake air is routed through both the low pressure compressor and then the high pressure compressor. This leads to the fact that each compressor can provide half of the needed pressure ratio (e.g. 2×2=4). With this solution, the high value of the compressor outlet temperature can be avoided. On the other hand, the use of the “full series” mode creates quite high back pressure in the exhaust manifold, mainly due to the high pressure turbine, which is the smaller turbine. Of course, high back pressure in the exhaust manifold means a loss of engine power. If a larger high pressure turbine were used this would lead to a worsening of the transient phases, therefore a larger turbine is not a proper solution.

Therefore a need exists for a new two-stage charging system configuration for high powered internal combustion engines, in particular, diesel engine having a specific output in the range of 90 kW/l and higher.

### SUMMARY

The present disclosure provides a new two-stage charging system configuration for high powered internal combustion engines, having two turbochargers, which are switchable according to a new arrangement of the switching valves.

An embodiment of the disclosure provides a two-stage turbocharger system for an internal combustion engine. The turbocharger system includes a high pressure turbine coupled to an exhaust manifold of the internal combustion engine, and a low pressure turbine, whose inlet is coupled to the high pressure turbine and whose outlet is coupled to an exhaust system of the engine. The turbocharger system further includes a low pressure compressor, whose inlet is coupled to environment and whose outlet is coupled to a high pressure compressor. The high pressure compressor is also coupled to an intake manifold of the internal combustion engine. The high pressure turbine is provided with a high pressure by-pass line, including a high pressure controlled by-pass valve. The low pressure turbine is provided with a low pressure by-pass line, including a low pressure controlled by-pass valve. A controlled valve is provided between the high pressure turbine and the low pressure turbine.

An advantage of this embodiment is that it provides a two-stage turbocharger system with a relatively flexible configuration, which can support high powered internal combustion engines in each operating conditions. In fact, such system, operating the compressors in full series reduces the outlet temperature of the compression stages. By selectively switching the turbine controlled valves, the turbines work in series, in parallel or in mixed configuration, according to the needs, thus containing the exhaust gas back pressure in the exhaust manifold at acceptable values.

According to a further embodiment, the high pressure turbine and the low pressure turbine are coupled by a duct, including the controlled valve. The high pressure by-pass line is a fluid connection between a node of the exhaust manifold and a first node of the duct coupling the turbines. The low pressure by-pass line is a fluid connection between a second node of the duct coupling the turbines and a node of an exhaust pipe of the exhaust system. In this way, three paths can be defined through each of the controlled valve or controlled by-pass lines. The gases can flow through one or more of these paths, according to the related valve opening.

According to another embodiment of the present disclosure, the high pressure turbine is a variable geometry turbine. An advantage of this embodiment is that a variable geometry turbine can be optimized according to the engine operating conditions, by changing the width of the passage vanes of its distributor and more particularly, by increasing them when the exhaust gas flow-rate increases.

According to a further embodiment of the present disclosure, the low pressure turbine is a fixed geometry turbine. An advantage of this further embodiment is that the second low pressure controlled by-pass can act as a waste-gate valve, and therefore a variable geometry turbine is not needed. As known, a fixed geometry turbine is cheaper and therefore the cost of such two-stage turbocharger system can be kept at an acceptable level.

According to another embodiment, a low pressure intercooler is located in an air intake pipe between the low pressure compressor and the high pressure compressor. As known, the intercooler decreases the temperature of the compressed air, thus allowing the compressed air reaching, for a given pressure value, a higher density value.

According to still another embodiment, a high pressure intercooler is located in the air intake pipe between the high pressure compressor and the intake manifold. An advantage of this embodiment, as for the previous one, is to allow the compressed air reaching, for a given pressure value, a higher density value.

According to a further embodiment, the two-stage turbocharger system is configured to close the high pressure controlled by-pass valve and the low pressure controlled by-pass valve and to open the controlled valve at low engine speed values, so that exhaust gases flow from the exhaust manifold, via the high pressure turbine, the controlled valve, and the low pressure turbine, to the exhaust system. An advantage of this embodiment is that the turbines operate in full series conditions recovering the exhaust gas enthalpy as much as possible.

According to a still further embodiment, the two-stage turbocharger system is configured to close the low pressure controlled by-pass valve and to open the high pressure controlled by-pass valve and the controlled valve at intermediate engine speed values so that a first given amount of the exhaust gases flow from the exhaust manifold, via the high pressure turbine, the controlled valve and the low pressure turbine, to the exhaust system, while a second given amount of the exhaust gases flow from the exhaust manifold, via the high pressure controlled by-pass line and the low pressure turbine, to the exhaust system. An advantage of this embodiment is that such mixed series-parallel configuration is a good compromise for keeping the back pressure in the exhaust manifold, created by a bigger flow-rate of the exhaust gas, at acceptable values, since the turbines work partly in parallel.

According to another embodiment, the two-stage turbocharger system is configured to close the controlled valve and to open the high pressure controlled by-pass valve and the low pressure controlled by-pass valve at high engine speed values, so that a first given amount of the exhaust gases flow from the exhaust manifold, via the high pressure turbine and the low pressure controlled by-pass line, to the exhaust system, while a second given amount of the exhaust gases flow from the exhaust manifold, via the high pressure controlled by-pass line and the low pressure turbine, to the exhaust system. An advantage of this embodiment is that such configuration is a full parallel mode and is very suitable when the engine is operating at peak power since the back pressure in the exhaust manifold is compensated by let the turbines completely work in parallel.

According to still another embodiment, an internal combustion engine is provided, the engine including an intake manifold, an exhaust manifold and a two-stage turbocharger system, according to any of the previous embodiments.

### BRIEF DESCRIPTION OF THE DRAWINGS

The present disclosure will hereinafter be described in conjunction with the following drawing figures, wherein like numerals denote like elements.

FIG. 1 is a section of the internal combustion engine;

FIG. 2 is a simplified scheme of an internal combustion engine provided with a two-stage turbocharger configuration according to the present disclosure;

FIG. 3 is a first operating scheme of the turbocharger configuration of FIG. 2 showing the arrangement of the controlled by-pass valves at engine low load;

FIG. 4 is a second operating scheme of the turbocharger configuration of FIG. 2, showing the arrangement of the controlled by-pass valves at engine part load; and

FIG. 5 is a third operating scheme of the turbocharger configuration of FIG. 2, showing the arrangement of the controlled by-pass valves at engine high load.

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background or the following detailed description.

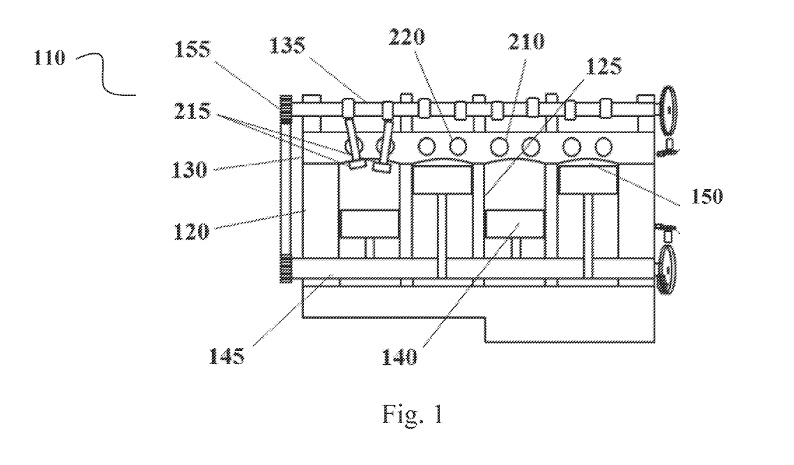

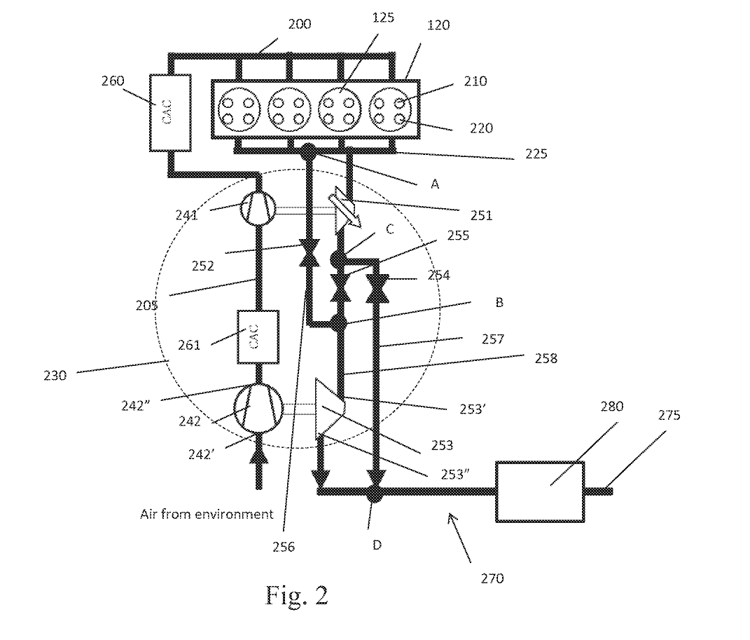

FIGS. 1 and 2 show an embodiment of a two-stage turbocharged internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector (not shown) and the air through at least one intake port 210. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

An air intake duct 205 may provide air from the ambient environment to the intake manifold 200, and then the air may be distributed to the air intake port(s) 210 through the intake manifold 200. A forced air system such as a turbocharger is also provided. The turbocharger is a two-stage turbocharger system 230, having one high pressure stage turbocharger and one low pressure stage turbocharger. The high pressure (HP) turbine 251 is coupled with the exhaust manifold 225, receiving the exhaust gas from it. The turbine can have a fixed or a variable geometry and is provided with a high pressure by-pass line 256, with a high pressure controlled by-pass valve 252. This by-pass line directly connects the exhaust manifold with the low pressure turbine 253. The inlet 253′ of the low pressure (LP) turbine 253 is coupled to the high pressure turbine, from which receives the exhaust gas and the outlet 253″ of the LP turbine is coupled to the exhaust system 270 of the internal combustion engine, which may include an exhaust pipe 275 having one or more exhaust after-treatment devices 280. The LP turbine could also be a VGT turbine or, as in the example of FIG. 2, a fixed geometry turbine, provided with a low pressure by-pass line 257, including a low pressure controlled by-pass valve 254. A controlled valve 255 is located between the HP turbine and the LP turbine. The inlet 242′ of the low pressure compressor 242 is coupled to environment, from which it receives the air and compresses it. The LP compressor outlet 242″ is coupled to the high pressure compressor 241. The high pressure compressor accomplishes a second stage of charge air compression before delivering the charge air to the intake manifold 200. In the air intake pipe 205, between the low pressure compressor 242 and the high pressure compressor 241 a low pressure intercooler 261 can be provided, as in the example of FIG. 2. Also in the air intake pipe 205, between the high pressure compressor 241 and the intake manifold 200, a high pressure intercooler 260 can be provided as well. As known, the intercooler decreases the temperature of the compressed air, thus allowing the air reaching (for a given pressure value) a higher density value.

An embodiment of the present disclosure defines a new controlled valve system, enabling to switch the turbine operation from serial sequential mode and operate the turbines in parallel mode at peak power, so that they can share the work load. In this way, the choice of big turbine sizes, which compromise the transient performance, can be avoided. To this purpose, the high pressure turbine 251 is provided with a high pressure by-pass line 256, including a high pressure controlled by-pass valve 252 and directly connecting the exhaust manifold with the low pressure turbine 253; moreover, the low pressure turbine 253 is provided with a low pressure by-pass line 257, including a low pressure controlled by-pass valve 254 and directly connecting the high pressure turbine with the exhaust system of the engine; finally, a controlled valve 255 is located between the HP turbine and the LP turbine. In this way, three paths can be defined through each of the controlled valve or controlled by-pass valves. The gases can flow through one or more of these paths, according to the related valve opening. More in detail, as also shown in FIG. 2, the high pressure turbine and the low pressure turbine are coupled by a duct 258, along which the controlled valve 255 is located, the high pressure by-pass line 256 connects a node A of the exhaust manifold 225 and a first node B of the duct 258, the low pressure by-pass line 257 connects a second node C of the duct 258 and a node D of the exhaust pipe 275 of the exhaust system 270.

On the other hand, the compressors operate always in full series mode, therefore sharing the pressure ratio at peak power. In fact, no controlled by-pass valves are provided for both the low pressure compressor 242 and the high pressure compressor 241.

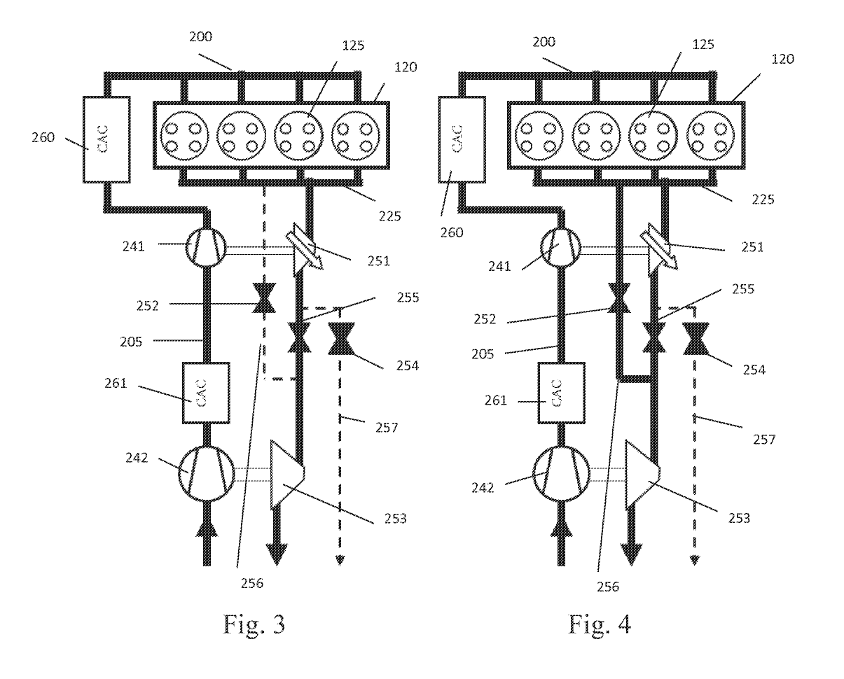

In FIG. 3, the operating mode of the turbocharger system at low engine speed is explained. As already mentioned, the compressors operate in full series mode. This means that the low pressure compressor 242 takes in air from the atmosphere, compresses it, and delivers it to the high pressure compressor 241 and the high pressure compressor stage accomplishes a second stage of charge air compression before delivering the charge air to the intake manifold 200 of the internal combustion engine. The compressor operating mode is the same also for other engine operating conditions (intermediate and high speed) and therefore will not be repeated anymore. The fact that the compressors share the pressure ratio at peak power avoids high value of the compressor outlet temperatures and consequent oil coking in the compressor.

At low engine speed (that is to say, approximately from 1000 to 1500 rpm), the turbine stages operate in full series mode. In fact, as shown in FIG. 3, the high pressure controlled by-pass valve 252 is closed and the low pressure controlled by-pass valve 254 is closed as well (dotted lines meaning no exhaust gas flow). Therefore, the exhaust gas flows from the exhaust manifold 225 to the high pressure turbine 251 and then, through the controlled valve 255, which is open, to the low pressure turbine 253 and then to the exhaust system. This configuration is really suitable at low engine speed, since the exhaust gas flow-rate is small and does not create big back pressure in the exhaust manifold, not penalizing the thermodynamic efficiency of the internal combustion engine. On the other hand, both turbines can work recovering the exhaust gas enthalpy as much as possible.

In intermediate engine operating conditions, namely with the engine performing at intermediate speed, approximately from 1500 to 3000 rpm, the configuration of the valve system is the one shown in FIG. 4. As can be observed, the low pressure controlled by-pass valve 254 is closed (dotted line) and no exhaust gas can flow through it, while the high pressure controlled by-pass valve 252 and the controlled valve 255 are both open. According to this configuration a first given amount of the exhaust gas flows from the exhaust manifold 225 to the high pressure turbine 251 and then, through the controlled valve 255, to the low pressure turbine 253; a second given amount of the gas directly flows from the exhaust manifold 225, through the high pressure controlled by-pass valve 252, to the low pressure turbine 253; finally, the whole amount of exhaust gas is discharged into the exhaust system. Such layout can be understood as a mixed series-parallel configuration. This configuration is a good compromise in case the engine is operating at intermediate speed values: the back pressure in the exhaust manifold, created by a bigger flow-rate of the exhaust gas, is compensated by let the turbines work partly in parallel. On the other hand, both turbines can work (the high pressure one at least partly) recovering the exhaust gas enthalpy as much as possible.

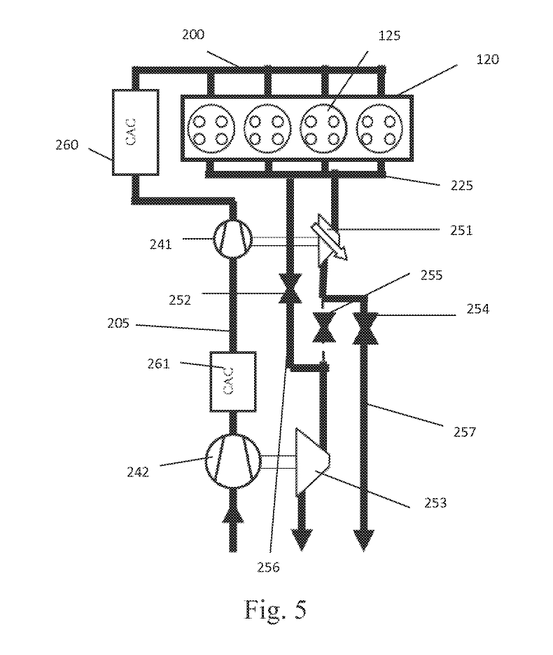

Finally, at peak engine operating conditions, namely with the engine performing at high speed, approximately from 3000 to 5000 rpm, the configuration of the controlled by-pass system is the one shown in FIG. 5. As can be observed, the controlled valve 255 is closed (dotted line) and no exhaust gas can flow through it, while the high pressure controlled by-pass valve 252 and the low pressure controlled by-pass valve 254 are both open. According to this configuration a first given amount of the exhaust gas flows from the exhaust manifold 225 to the high pressure turbine 251 and then, through the low pressure controlled by-pass valve 254, is discharged into the exhaust system, by-passing the low pressure turbine 253; a second given amount of the gas directly flows from the exhaust manifold 225, through the high pressure controlled by-pass valve 252, to the low pressure turbine 253 and then is discharged into the exhaust system. Such configuration is a full parallel mode and is very suitable when the engine is operating at peak power: the back pressure in the exhaust manifold, created by a bigger flow-rate of the exhaust gas, is compensated by let the turbines completely work in parallel. On the other hand, both turbines can work (at least partly) recovering the exhaust gas enthalpy as much as possible.

Summarizing, this new two-stage turbocharger system has a really flexible configuration, which can support high powered internal combustion engines in each operating conditions. In fact, from one hand, the fact that the compressors are always operating in series allows to reduce the outlet temperature of the compression stages. Moreover, from the turbine side, the different lay-out, which the controlled by-pas system can perform, allow to use small size turbines (at high power the turbine can work in parallel) thus improving the inertia during the engine transient conditions, and (by switching from a series configuration to a parallel configuration as soon as the exhaust gas flow-rate increases) allow to keep the exhaust gas back pressure in the exhaust manifold at acceptable values. Finally, this turbocharged system can work with two turbochargers, not having the need of further turbocharger stages for the same engine performance.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1-10. (canceled)

11. A two-stage turbocharger system for an internal combustion engine having an inlet manifold, an exhaust manifold and an exhaust system, the turbocharger system comprising:
a low pressure compressor having an inlet and an outlet;
a high pressure compressor having an inlet coupled to the low pressure compressor and an outlet configured to be coupled to the intake manifold;
a high pressure turbine having an outlet configured to be coupled to the exhaust manifold, the high pressure turbine further including a high pressure by-pass line and a high pressure controlled by-pass valve;
a low pressure turbine having an inlet coupled to the high pressure turbine and an outlet configured to be coupled to the exhaust system, the low pressure turbine further including a low pressure by-pass line and a low pressure controlled by-pass valve; and
a controlled valve between the high pressure turbine and the low pressure turbine.

12. The two-stage turbocharger system according to claim 11, further comprising a duct including said controlled valve coupling the high pressure turbine with the low pressure turbine, wherein the high pressure by-pass line provides a fluid connection between a node of the exhaust manifold and a first node of the duct, and wherein the low pressure by-pass line provides a fluid connection between a second node of the duct and a node of an exhaust pipe of the exhaust system.

13. The two-stage turbocharger system according to claim 11, wherein said high pressure turbine comprises a variable geometry turbine.

14. The two-stage turbocharger system according to claim 11, wherein said low pressure turbine comprises a fixed geometry turbine.

15. The two-stage turbocharger system according to claim 11, further comprising a low pressure intercooler located in an air intake pipe between the low pressure compressor and the high pressure compressor.

16. The two-stage turbocharger system according to claim 11, further comprising a high pressure intercooler located in an air intake pipe between the high pressure compressor and the intake manifold.

17. The two-stage turbocharger system according to claim 11, wherein the turbocharger system is configured to close the high pressure controlled by-pass valve and the low pressure controlled by-pass valve and to open the controlled valve at low engine speed value so that exhaust gases flow from the exhaust manifold to the exhaust system, via the high pressure turbine, the controlled valve and the low pressure turbine.

18. The two-stage turbocharger system, according to claim 11, wherein the turbocharger system is configured to close the low pressure controlled by-pass valve and to open the high pressure controlled by-pass valve and the controlled valve at intermediate engine speed values, wherein a first given amount of the exhaust gases flow from the exhaust manifold to the exhaust system via the high pressure turbine, the controlled valve and the low pressure turbine, and a second given amount of the exhaust gases flow from the exhaust manifold to the exhaust system via the high pressure controlled by-pass line and the low pressure turbine.

19. The two-stage turbocharger system according to claim 11, wherein the turbocharger system is configured to close the controlled valve and to open the high pressure controlled by-pass valve and the low pressure controlled by-pass valve at high engine speed values, wherein a first given amount of the exhaust gases flow from the exhaust manifold to the exhaust system via the high pressure turbine and the low pressure controlled by-pass line, and a second given amount of the exhaust gases flow from the exhaust manifold to the exhaust system via the high pressure controlled by-pass line and the low pressure turbine.

20. An internal combustion engine comprising:
an inlet manifold;
an exhaust manifold;
an exhaust system; and
a turbocharger system including:
a low pressure compressor having an inlet and an outlet;
a high pressure compressor having an inlet coupled to the low pressure compressor and an outlet coupled to the intake manifold;
a high pressure turbine having an outlet coupled to the exhaust manifold, the high pressure turbine including a high pressure by-pass line and a high pressure controlled by-pass valve;
a low pressure turbine having an inlet coupled to the high pressure turbine and an outlet coupled to the exhaust system, the low pressure turbine including a low pressure by-pass line and a low pressure controlled by-pass valve; and
a controlled valve between the high pressure turbine and the low pressure turbine.

21. The internal combustion engine according to claim 20, wherein the turbocharger system further comprises a duct including said controlled valve coupling the high pressure turbine with the low pressure turbine, wherein the high pressure by-pass line provides a fluid connection between a node of the exhaust manifold and a first node of the duct, and wherein the low pressure by-pass line provides a fluid connection between a second node of the duct and a node of an exhaust pipe of the exhaust system.

22. The internal combustion engine according to claim 20, wherein said high pressure turbine comprises a variable geometry turbine.

23. The internal combustion engine according to claim 20, wherein said low pressure turbine comprises a fixed geometry turbine.

24. The internal combustion engine according to claim 20, further comprising a low pressure intercooler located in an air intake pipe between the low pressure compressor and the high pressure compressor.

25. The internal combustion engine according to claim 20, further comprising a high pressure intercooler located in an air intake pipe between the high pressure compressor and the intake manifold.

26. The internal combustion engine according to claim 20, wherein the turbocharger system is configured to close the high pressure controlled by-pass valve and the low pressure controlled by-pass valve and to open the controlled valve at low engine speed value so that exhaust gases flow from the exhaust manifold to the exhaust system, via the high pressure turbine, the controlled valve and the low pressure turbine.

27. The internal combustion engine according to claim 20, wherein the turbocharger system is configured to close the low pressure controlled by-pass valve and to open the high pressure controlled by-pass valve and the controlled valve at intermediate engine speed values, wherein a first given amount of the exhaust gases flow from the exhaust manifold to the exhaust system via the high pressure turbine, the controlled valve and the low pressure turbine, and a second given amount of the exhaust gases flow from the exhaust manifold to the exhaust system via the high pressure controlled by-pass line and the low pressure turbine.

28. The internal combustion engine according to claim 20, wherein the turbocharger system is configured to close the controlled valve and to open the high pressure controlled by-pass valve and the low pressure controlled by-pass valve at high engine speed values, wherein a first given amount of the exhaust gases flow from the exhaust manifold to the exhaust system via the high pressure turbine and the low pressure controlled by-pass line, and a second given amount of the exhaust gases flow from the exhaust manifold to the exhaust system via the high pressure controlled by-pass line and the low pressure turbine.
